(19) United States
(12) Patent Application Publication
(10) Pub. No.: US 2020/0117794 A1
(43) Pub. Date: Apr. 16, 2020

(54) REESTABLISHING VOLTAGE PROFILES OF ELECTRONIC CONTROL UNITS AFTER RESET

(71) Applicant: Intel Corporation, Santa Clara, CA (US)

(72) Inventors: SHABBIR AHMED, Beaverton, OR (US); MARCIO JULIATO, Portland, OR (US); CHRISTOPHER GUTIERREZ, Hillsboro, OR (US); MANOJ SASTRY, Portland, OR (US); LIUYANG YANG, Portland, OR (US); XIRUO LIU, Portland, OR (US)

(73) Assignee: Intel Corporation, Santa Clara, CA (US)

(21) Appl. No.: 16/712,591

(22) Filed: Dec. 12, 2019

(51) Int. Cl. G06F 21/44; G06F 13/20; G05B 15/02

(52) U.S. Cl. CPC G06F 21/44; G05B 15/02; G06F 13/20

(57) ABSTRACT

Systems, apparatuses, and techniques for establishing “ground truth” are provided. Particularly, establishing ground truth for electronic control units on a communication network after a context change has occurred are provided. Circuitry and instructions to generate unique feature sets from messages (e.g., transmitted by ECUs after a context change) and to match the unique feature sets to unique feature sets from ECU fingerprints to establish ground truth for the ECUs after the context shift.

### TECHNICAL FIELD

Embodiments described herein generally relate to providing authentication for devices on a communication network, such as, an in-vehicle communication network.

### BACKGROUND

Communication networks are implemented in a variety of modern systems, such as, automotive, bus, train, industrial vehicle, agricultural vehicle, ship, aircraft, spacecraft, manufacturing, industrial, health devices/equipment, retail, or the like. Often, networking protocols are used to facilitate information communication between components in the system. For example, an in-vehicle network (IVN), like a CAN bus, can be used to provide a message-based protocol facilitating communication between electronic control units (e.g., microcontrollers, sensors, actuators, etc.). However, the increasingly high number of electronic control communication on such networks expose the systems to various types of security risks.

### BRIEF DESCRIPTION OF THE DRAWINGS

In the drawings, which are not necessarily drawn to scale, like numerals may describe similar components in different views Like numerals having different letter suffixes may represent different instances of similar components. The drawings illustrate generally, by way of example, but not by way of limitation, various embodiments discussed in the present document.

FIG. 1 illustrates a system to establish ground truth for ECUs on a network.

FIG. 2 illustrates a portion of the system of FIG. 1 is greater detail.

FIG. 3 illustrates a technique to establish ground truth for ECUs on a network.

FIG. 4A illustrates a mapping between messages and unique feature sets.

FIG. 4B illustrates a mapping between unique feature sets and ECU fingerprints.

FIG. 5 illustrates a logic flow to establish ground truth for ECUs on a network.

FIG. 6 illustrates an example non-transitory storage medium.

FIG. 7 illustrates an example in-vehicle communication architecture.

### DETAILED DESCRIPTION

Various embodiments of the present disclosure provide for establishing a “ground truth” for electronic control units (ECUs) on a communication network after a context shift has occurred. Conventionally, fingerprinting mechanisms must be retrained after each context shift. However, any retraining in the presence of an attacker (e.g., malicious ECU, or the like) can contaminate the fingerprinting process. Accordingly, the present disclosure provides to establish a “ground truth” that can be used as a network sanity check or to bootstrap the fingerprinting. This is described in greater detail below. In general, the present disclosure is directed towards establishing ground truth for ECUs coupled via a communication bus, which can be implemented in a variety of contexts, such as, for example, industrial networks, vehicular networks, manufacturing networks, retail operation networks, warehousing networks, or the like. Although vehicular networks are often used in this description as an example, the claims are not limited to in-vehicle networks.

However, using vehicles as an example, modern vehicles have many (often hundreds) of ECUs. These ECUs are communicatively coupled via an in-vehicle network (IVN), such as, as CAN bus. For example, there are multiple ECUs for engine control, transmission, airbags, antilock braking, cruise control, electric power steering, audio systems, power windows, power doors, power mirror adjustment, battery, recharging systems for hybrid/electric cars, environmental control systems, auto start stop systems, blind spot monitoring, lane keeping assist systems, collision avoidance systems, and more complex systems in the case of autonomous, or semi-autonomous vehicles.

Physical characteristics of these ECUs are often used in fingerprinting schemes to mitigate the risk of malicious ECUs masquerading as a valid ECU. For example, during operation, the ECUs generate and transmit messages onto the IVN. Physical characteristics of these messages (e.g., voltage profile characteristics, or the like) can be used to generate a fingerprint for each ECU. Subsequently, this fingerprint can be used to ensure that messages indicated as originating from a particular ECU (e.g., the anti-lock brake ECU, or the like) has indeed originated from the authentic ECU.

However, where the system encounters a context shift, the accuracy of these fingerprints may degrade and no longer be valid. Said differently, a change in the physical environment in which the physical characteristics are measured can change the fingerprint of each ECU. For example, an automobile parked overnight will encounter a context shift (e.g., due to changes in temperature, humidity, cooling of vehicle components, or the like) that may affect the fingerprint of the ECUs in the automobile.

The present disclosure provides for bootstrapping the reestablishment of ground truth for fingerprinting mechanisms. In some examples, the present disclosure can be provided to bootstrap (or validate) fingerprinting without requiring retraining of the fingerprints. In other examples, the present disclosure can be provided to bootstrap a fingerprint retraining process to ensure that attackers (e.g., a malicious ECU masquerading as a valid ECU) are not present during the re-training process. In the following description, numerous specific details such as processor and system configurations are set forth in order to provide a more thorough understanding of the described embodiments. However, the described embodiments may be practiced without such specific details. Additionally, some well-known structures, circuits, and the like have not been shown in detail, to avoid unnecessarily obscuring the described embodiments.

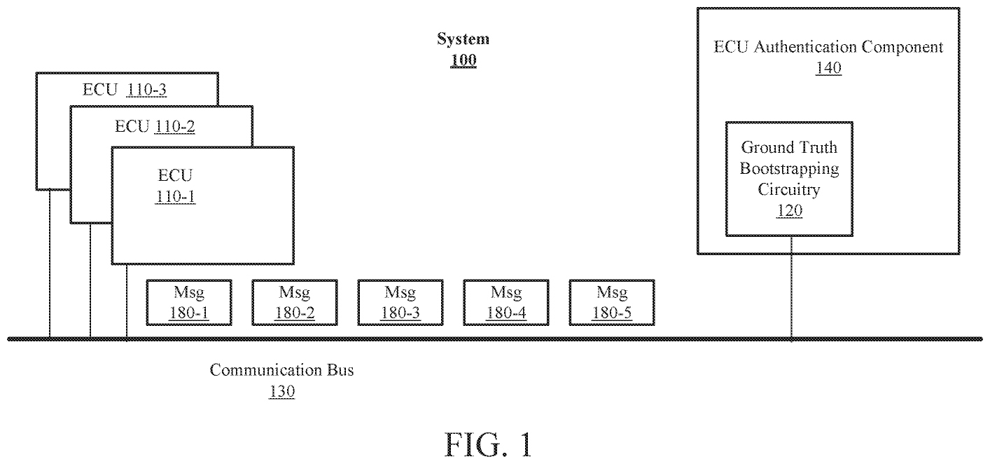

FIG. 1 illustrates an example system 100, which can be implemented in a vehicle, such as, for example, an automobile, a motorcycle, an airplane, a boat, a personal watercraft, an all-terrain vehicle, or the like. System 100 includes a number of electronic control units (ECUs) 110 and ground truth bootstrapping circuitry 120. For example, ECUs 110-1, 110-2, and 110-3 are depicted. However, any number of ECUs can be provided. ECUs 110 and ground truth bootstrapping circuitry 120 are communicatively coupled via communication bus 130. In some examples, communication bus 130 can be any network where ECUs are arranged to transmit and consume messages from. As a specific example, communication bus 130 can be an in-vehicle network (IVN), such as, for example, a CAN bus, a FlexRay bus, a CAN FD bus, an automotive ethernet bus, or a local interconnected network (LIN) bus. Additionally, where implemented in contexts outside of the automotive space, the communication bus 130 can be a network adapted to the implementation, such as, for example, a communication network for manufacturing equipment, or the like.

In general, ECUs 110 include circuitry arranged to consume messages and/or send messages via communication bus 130. For example, ECU 110 can include processing circuitry and memory (not shown), where the memory can include instructions (e.g., firmware) arranged to control the ECU. In some examples, the ECU 110 can include sensor components. For example, returning to the example of a vehicle, some common sensors are speed sensors, tire pressure sensors, mass airflow sensors, oxygen sensors, to name just a few. An exhaustive list of sensors is not provided for brevity.

During operation, ECUs 110 can be arranged to generate a message (msg) 180 comprising an indication of some information, environmental condition, other data, control signal, command, or the like. For example, in the case of ECU 110-1 being a speed sensor, ECU 110-1 can generate messages 180 including an indication of a vehicle speed, a wheel speed, or the like. As another example, in the case of ECU 110-2 being an anti-lock brake controller, ECU 110-2 can transmit a message 180 comprising a command to actuate an electronic braking system. As depicted, messages 180-1, 180-2, 180-3, 180-4, and 180-5 are depicted having been generated and transmitted onto communication bus 130.

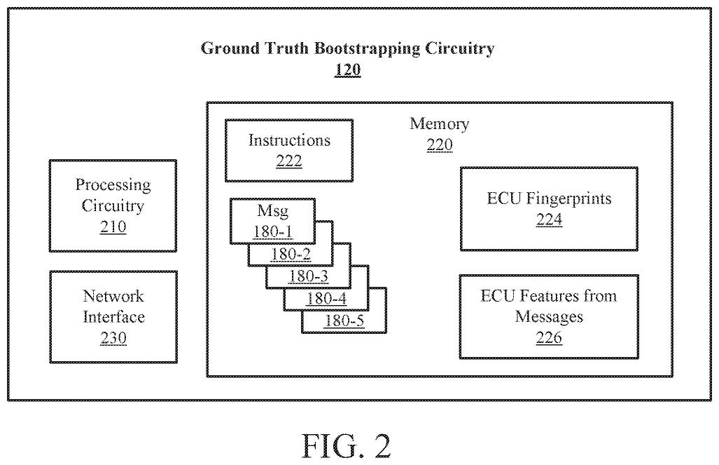

With some examples, ground truth bootstrapping circuitry 120 can be included as part of an ECU authentication component 140. In other examples, the ground truth bootstrapping circuitry 120 can be a stand-alone component of the system 100. In general, ECU authentication component 140 can include circuitry (e.g., processing circuitry, memory, etc.) arranged to authenticate ECUs 110 in system 100. ECU authentication component 140 can generate fingerprints for each of ECUs 110 (see FIG. 2). Subsequently, during operation, ECU authentication component can use the generated fingerprints to check the authenticity of the messages sent by an ECU. Said differently, ECU authentication component can inspect messages 180 from communication bus 130 and determine whether the messages originate from the ECU 110 with which the message 180 indicates. As noted, the present disclosure provides for establishing ground truth for ECU fingerprinting. That is, the present disclosure provides to validate the fingerprints after a context change. It is to be appreciated that the techniques provided herein to bootstrap ground truth for ECU fingerprints can be applied independent of the actual ECU fingerprinting method.

In general, ground truth bootstrapping circuitry 120 consumes messages 180 and groups the messages 180 into groups based on a feature or features of the messages. This grouping is used to validate prior fingerprints for the ECUs 100. This is explained in greater detail below. FIG. 2 illustrates an example ground truth bootstrapping circuitry 120. As can be seen, ground truth bootstrapping circuitry 120 includes processing circuitry 210, memory 220, and network interface 230.

Processing circuitry 210 can include any of a variety of processors, such as, for example, commercial central processing units, application specific integrated circuits, microprocessors, or the like. That is, processing circuitry 210 can be a microprocessor or a commercial processor and can include multiple processing core(s) and cache.

Memory 220 can be based on any of a wide variety of information storage technologies. For example, memory 220 can be based on volatile technologies requiring the uninterrupted provision of electric power or non-volatile technologies that do not require and possibly including technologies entailing the use of machine-readable storage media that may or may not be removable. Thus, each of these storages may include any of a wide variety of types (or combination of types) of storage devices, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM

(EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array).

Networking interface 230 can be any of a variety of circuitry arranged to accept, communicate, and connect to one or more external communications networks (e.g., communication bus 130, or the like).

As depicted, memory 220 includes instructions 222, messages 180, ECU fingerprints 224, and ECU features from messages 226. During operation, processing circuitry 210 can execute instructions 222 to consume messages 180 from communication bus 130 (e.g., via network interface 230, or the like). In particular, after a context change, processing circuitry 210 can execute instructions 222 to gather consume messages 180 from communication bus 130. Subsequently, processing circuitry can execute instructions 222 to generate, based on messages, ECU features from messages 226 messages. In executing instructions 222, processing circuitry 210 can validate ECU fingerprints 224, or establish a ground truth for ECU fingerprints 224 based on ECU features from messages 226. This is explained in greater detail below.

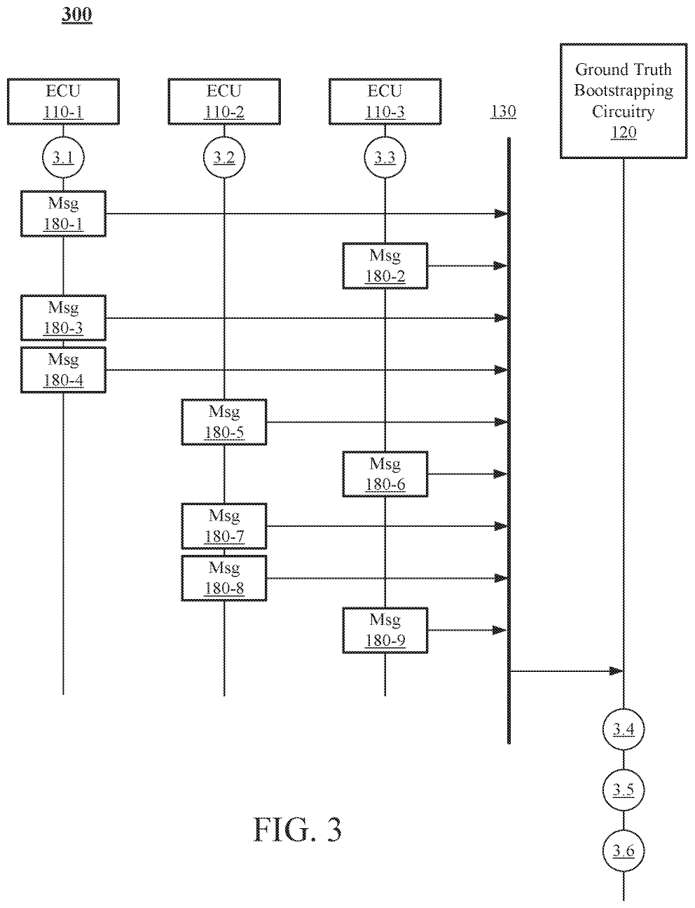

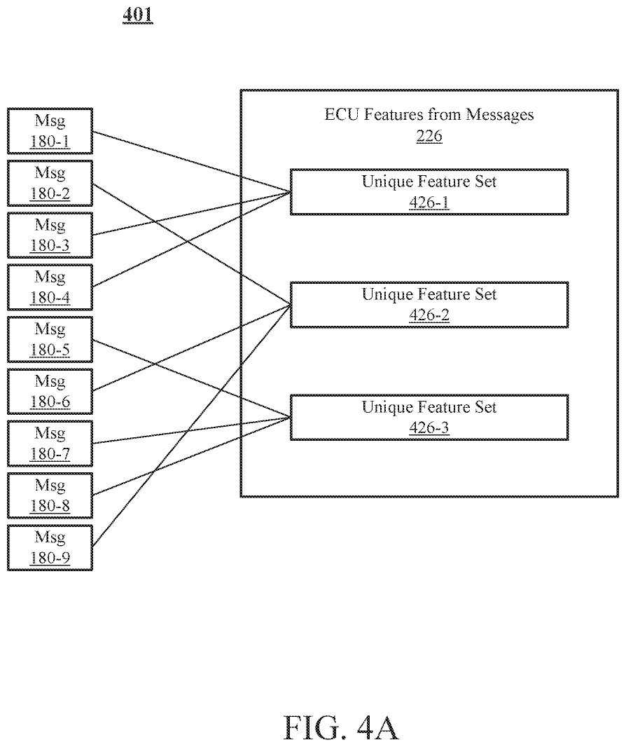

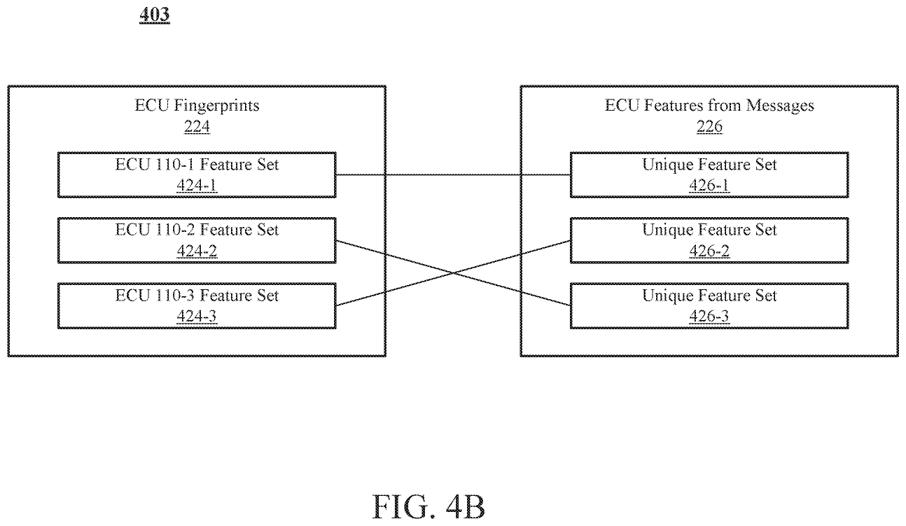

FIG. 3 illustrates a technique 300, which can be implemented to establish ground truth for ECUs sending messages on a communication network. Particularly, technique 300 can be used to establish ground truth after a context shift. Technique 300 is described with reference to the system 100 of FIGS. 1-2 and also of the mapping of messages to features and features to fingerprints in FIGS. 4A and 4B. However, technique 300 can be implemented with a system different than that depicted in FIGS. 1 and 2. Examples are not limited in this context.

Technique 300 can begin at circles 3.1, 3.2, and 3.3. At circles 3.1, 3.2, and 3.3, ECUs 110 can generate and transmit messages 180 onto communication bus 130. For example, this figure depicts ECU 110-1 generating messages 180-1, 180-3, and 180-4 at circle 3.1. Similarly, at circle 3.2, ECU 110-2 is depicted generating messages 180-5, 180-7, and 180-8; while at circle 3.3, ECU 110-3 is depicted generating messages 180-2, 180-6, and 180-9. It is noted, that ECUs 110-1, 110-2, and 100-3 can generate messages 180 simultaneous or around the same time. That is, ECUs 110 may not generate messages in any particular order. Furthermore, as noted herein, technique 300 may be performed after a context shift (e.g., a vehicle parked overnight, or the like). Continuing to circle 3.4, ground truth bootstrapping circuitry 120 can consume messages 180 from communication bus 120. That is, processing 210 in executing instructions 222 can read messages 180 from communication bus 130.

Continuing to circle 3.5, ground truth bootstrapping circuitry 120 can group messages 180 based on unique characteristics of the messages. That is, processing circuitry 210 in executing instructions 222 can group messages 180 based on unique features or characteristics of the messages. In general, the unique features or characteristics of the messages can be any physical characteristic of the message or the manner that the message is transmitted. For example, the unique features or characteristics can be voltage characteristics of the message being transmitted on the communication bus (e.g., a two-dimensional plot of the rising edge or falling edge, dominant voltage level, recessive voltage levels, width of each bit, clock skew, timing, or the like). As another example, the unique features of characteristics can involve extracting statistical features from the signal like mean, median, percentile, standard deviation, RMS, successive average, kurtosis, skewness, energy, power or the like.

As depicted in FIG. 4A, messages 180 can be mapped into unique feature set groups 426. That is, ground truth bootstrapping circuitry 120 can group messages 180 into groups based on unique features or characteristics of the messages 180. Said differently, messages 180 with similar features or characteristics (e.g., feature that are within threshold values, within a standard deviation, or the like) can be grouped into the same group. In some examples, similarity can be measured based on clustering within a deviation or threshold, convolutions, or the like. This figure depicts mapping 401 which shows messages 180 from the technique 300 grouped based on unique feature sets 426. Specifically, unique feature set 426-1, 426-2, and 426-3 are depicted. As can be seen, messages 180-1, 180-3, and 180-4 are grouped into unique feature set 426-1, messages 180-2, 180-6, and 180-9 are grouped into unique feature set 426-2, and messages 180-5, 180-7, and 180-8 are grouped into unique feature set 426-3.

Continuing to circle 3.6, ground truth bootstrapping circuitry 120 can establish the ground truth for ECUs 110 based on the ECU features from messages 226. Said differently, ECU fingerprints 224 can be validated, or reestablished, based on ECU features from messages 226. That is, processing circuitry 210 in executing instructions 222 can establish the ground truth for ECUs 110 in system 100 based on ECU fingerprints 224 and ECU features from messages generated at circle 3.5. For example, as depicted by mapping 403 in FIG. 4B, ECU fingerprints 224 include feature sets 424 corresponding to ECUs 110 in system 100. Specifically, as depicted, ECU fingerprints 224 include ECU 110-1 features set, ECU 110-2 feature set, and ECU 110-3 feature set.

Processing 210, in executing instructions 222 can compare ECU feature sets 424 from ECU fingerprints to unique feature sets 426 from ECU features from messages 226. Ground truth bootstrapping circuitry 120 can establish the ground truth for ECUs 110 in system 100 based on matching the ECU feature sets 424 from the ECU fingerprints 224 with the feature sets 426 from the ECU features from messages 226. As another example, a message identifier (ID) from messages 180 in each feature set 426 can be analyzed to determine whether the messages are indicated as originating from the same ECU 110 to establish the ground truth for ECU fingerprints 224.

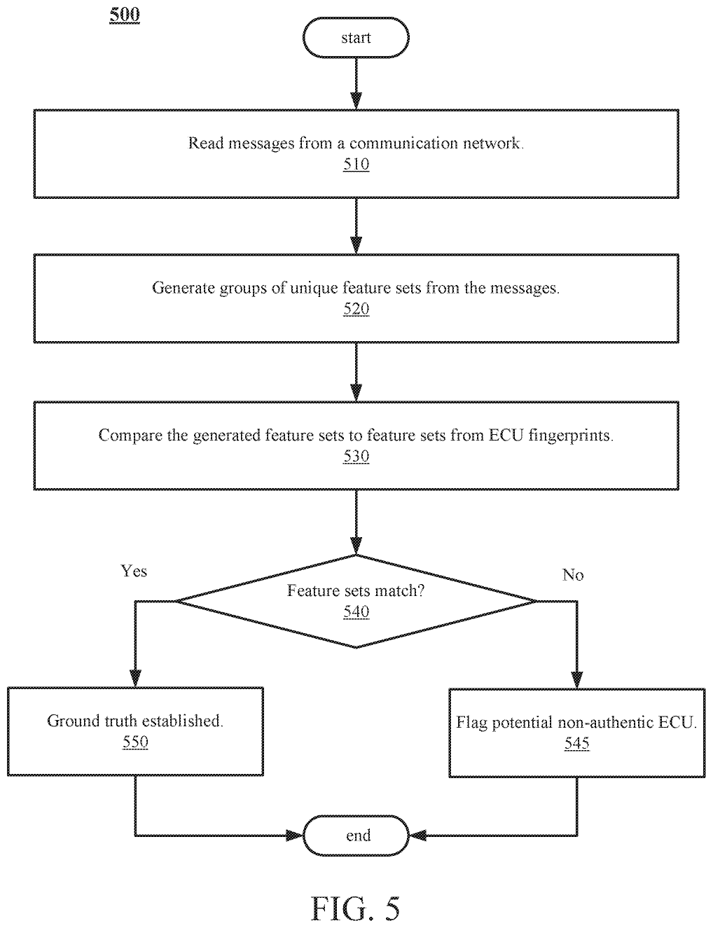

FIG. 5 depicts a logic flow 500. Logic flow 500 can be implemented by circuitry as part of an ECU authentication system. More specifically, logic flow 500 can be implemented by ground truth bootstrapping circuitry 120 of system 100. Logic flow 500 as well as the technique 300 are representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

Logic flow 500 may begin at block 510. At block 510 “read messages from a communication network” processing circuitry can receive message from a communication network. For example, processing circuitry 210 of ground truth bootstrapping circuitry 120 can receive message 180 from communication bus 120. For example, processing circuitry 210, in executing instructions 222, can read messages 180 and store messages 180 in memory 220. Continuing to block 520 “generate groups of unique feature sets from the messages” processing circuitry can generate a number of unique feature sets from the messages read at block 510. For example, processing circuitry 210, in executing instructions 222, can generate unique feature sets 426 from messages 180 read at block 510.

Continuing to block 530 “compare the generated feature sets to feature sets from ECU fingerprints” processing circuitry can compare the feature sets generated at block 520 with feature sets from ECU fingerprints. For example, processing circuitry 210, in executing instructions 222, can compare feature sets 426 of ECU feature sets from messages 226 with feature sets 424 from ECU fingerprints 224.

Continuing to decision block 540 “feature sets match?” processing circuitry can determine whether the features sets match. That is, processing circuitry can determine whether the feature sets generated at block 520 match the ECU fingerprint feature sets, based on the comparison from block 530. For example, processing circuitry 210, in executing instructions 222, can determine whether the feature sets 426 of ECU feature sets from messages 226 match the feature sets 424 from ECU fingerprints 224 based on the comparison from block 530. From decision block 540, logic flow 500 can continue to either block 545 or block 550. Particularly, logic flow 500 can continue from decision block 540 to block 550 based on a determination that the feature sets match while logic flow 500 can continue from decision block 540 to block 545 based on a determination that the feature sets do not match.

At block 545 “flag potential non-authentic ECU” processing circuitry can flag a potential non-authentic ECU. For example, where the generated feature sets 426 do not match with the feature sets 424 from ECU fingerprints, processing circuitry 210 can flag (e.g., generate a notification, generate an error code, or the like) indicating that potentially non-authentic ECU is present. With some implementations, at block 545, ground truth will not be established, and the ECU fingerprints can be retrained at block 545. At block 550 “ground truth established” processing circuitry can establish ground truth for ECU fingerprints after the context change.

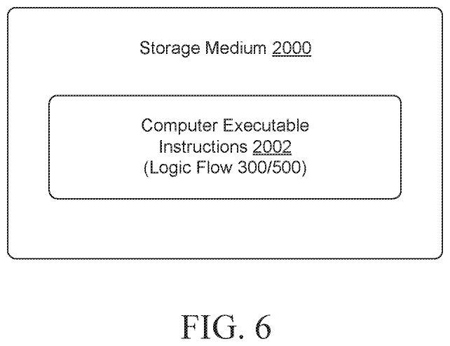

FIG. 6 illustrates an example of a storage medium 2000. Storage medium 2000 may comprise an article of manufacture. In some examples, storage medium 2000 may include any non-transitory computer readable medium or machine readable medium, such as an optical, magnetic or semiconductor storage. Storage medium 2000 may store various types of computer executable instructions, such as instructions to implement technique 300 or logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

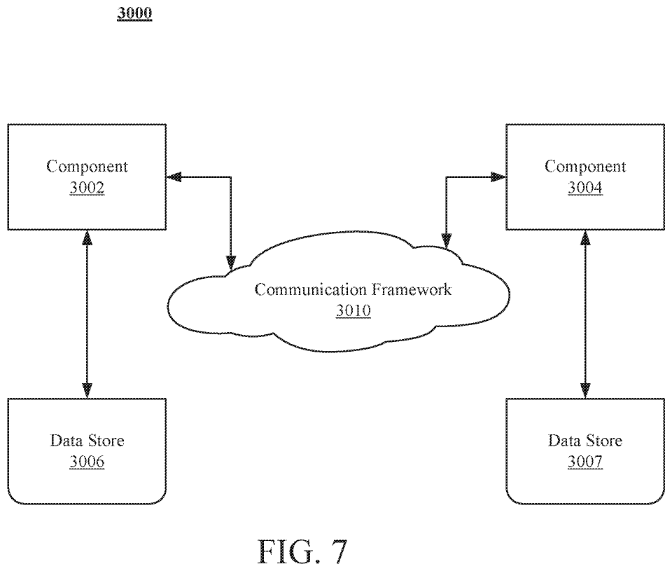

FIG. 7 illustrates an exemplary in-vehicle communications architecture 3000 according to one or more embodiments of the disclosure. For example, one or more vehicular components, such as component 3002 and 3004, may communicate with each other via a communications framework 3010, which may be an in-vehicle network, such as a CAN bus, implemented to facilitate authentication and confidentiality mechanisms during communications over the network, as described above.

The communications architecture 3000 includes various common communications elements, such as a transmitter, receiver, transceiver, and so forth. The embodiments, however, are not limited to implementation by the communications architecture 3000.

As shown in FIG. 7, the vehicular components 3002 and 3004 may each be operatively connected to one or more respective client data stores 3006 and 3007 that can be employed to store information local to the respective components 3002 and 3004, such as cookies and/or associated contextual information. It may be understood that the components 3002 and 3004 may be any suitable vehicular component, such as sensor, an ECU, microcontroller, microprocessor, processor, ASIC, field programmable gate array (FPGA), any electronic device, computing device, or the like. Moreover, it may be understood that one or more computing devices (containing at least a processor, memory, interfaces, etc.) may be connected to the communication framework 3010 in a vehicle.

Further, the communications framework 3010 may implement any well-known communications techniques and protocols. As described above, the communications framework 3010 may be implemented as a CAN bus protocol or any other suitable in-vehicle communication protocol.

The communications framework 3010 may also implement various network interfaces arranged to accept, communicate, and connect to one or more external communications networks (e.g., Internet). A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. The communication framework 3010 may employ both wired and wireless connections.

The components and features of the devices described above may be implemented using any combination of: processing circuitry, discrete circuitry, application specific integrated circuits (ASICs), logic gates and/or single chip architectures, etc. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodology, but one of ordinary skill in the art may recognize that many further combinations and permutations are possible. Accordingly, the novel architecture is intended to embrace all such alterations, modifications and variations that fall within the spirit and scope of the appended claims.

The following examples pertain to further embodiments, from which numerous permutations and configurations will be apparent.

### Example 1

An apparatus comprising: processing circuitry; and memory coupled to the processing circuitry, the memory comprising instructions that when executed by the processing circuitry cause the processing circuitry to: read, from a communication bus, a plurality of messages generated by a plurality of electronic control units (ECUs), generate, based in part on the plurality of messages, a plurality of feature sets, and establish a ground truth for the plurality of ECUs based in part on the plurality of feature sets.

### Example 2

The apparatus of claim 1, the instructions when executed by the processing circuitry cause the processing circuitry to compare the plurality of feature sets to a plurality of fingerprint feature sets associated with the plurality of ECUs.

### Example 3

The apparatus of claim 2, the instructions when executed by the processing circuitry cause the processing circuitry to receive ECU fingerprints, the ECU fingerprints comprising the plurality of fingerprint feature sets.

### Example 4

The apparatus of claim 1, the instructions when executed by the processing circuitry cause the processing circuitry to generate the plurality of feature sets based in part on physical characteristics of the plurality of messages.

### Example 5

The apparatus of claim 1, the instructions when executed by the processing circuitry cause the processing circuitry to: determine, for each of the plurality of messages, a physical characteristic of the message; designate a first message of the plurality of messages as belonging to a first feature set of the plurality of feature sets based on the physical characteristics of the first message; and designate a second message of the plurality of messages as belonging to a first set of the plurality of feature sets based on the physical characteristics of the second message, wherein the physical characteristic of the first message is within a threshold value of the physical characteristic of the second message.

### Example 6

The apparatus of claim 5, the instructions when executed by the processing circuitry cause the processing circuitry to designate a third message of the plurality of messages as belonging to a second feature set of the plurality of feature sets based on the physical characteristics of the third message, wherein the physical characteristic of the third message is outside a threshold value of the physical characteristic of the first message or the second message.

### Example 7

The apparatus of claim 1, the communication bus a controller area network (CAN) bus, CAN FD, a FlexRay bus, an automotive ethernet bus, or a local interconnected network (LIN) bus.

### Example 8

A system, comprising: a communication bus; a plurality of electronic control units coupled to the communication bus; and a ground truth fingerprint device, comprising: processing circuitry; and memory coupled to the processing circuitry, the memory comprising instructions that when executed by the processing circuitry cause the processing circuitry to: read, from a communication bus, a plurality of messages generated by a plurality of electronic control units (ECUs), generate, based in part on the plurality of messages, a plurality of feature sets, and establish a ground truth for the plurality of ECUs based in part on the plurality of feature sets.

### Example 9

The system of claim 8, the instructions when executed by the processing circuitry cause the processing circuitry to compare the plurality of feature sets to a plurality of fingerprint feature sets associated with the plurality of ECUs.

### Example 10

The system of claim 9, the instructions when executed by the processing circuitry cause the processing circuitry to receive ECU fingerprints, the ECU fingerprints comprising the plurality of fingerprint feature sets.

### Example 11

The system of claim 8, the instructions when executed by the processing circuitry cause the processing circuitry to generate the plurality of feature sets based in part on physical characteristics of the plurality of messages.

### Example 12

The system of claim 8, the instructions when executed by the processing circuitry cause the processing circuitry to: determine, for each of the plurality of messages, a physical characteristic of the message; designate a first message of the plurality of messages as belonging to a first feature set of the plurality of feature sets based on the physical characteristics of the first message; and designate a second message of the plurality of messages as belonging to a first set of the plurality of feature sets based on the physical characteristics of the second message, wherein the physical characteristic of the first message is within a threshold value of the physical characteristic of the second message.

### Example 13

The system of claim 12, the instructions when executed by the processing circuitry cause the processing circuitry to designate a third message of the plurality of messages as belonging to a second feature set of the plurality of feature sets based on the physical characteristics of the third message, wherein the physical characteristic of the third message is outside a threshold value of the physical characteristic of the first message or the second message.

### Example 14

The system of claim 8, the communication bus a controller area network (CAN) bus, CAN FD, a FlexRay bus, an automotive ethernet bus, or a local interconnected network (LIN) bus.

### Example 15

A computer-readable storage medium for a ground truth fingerprint device of an in-vehicle network (IVN), that medium comprising instructions for execution by circuitry, which when executed by the circuitry cause the circuitry to: read, from an in-vehicle network (IVN), a plurality of messages generated by a plurality of electronic control units (ECUs), generate, based in part on the plurality of messages, a plurality of feature sets, and establish a ground truth for the plurality of ECUs based in part on the plurality of feature sets.

### Example 16

The computer-readable storage medium of claim 15, the instructions when executed by the circuitry cause the circuitry to compare the plurality of feature sets to a plurality of fingerprint feature sets associated with the plurality of ECUs.

### Example 17

The computer-readable storage medium of claim 16, the instructions when executed by the circuitry cause the circuitry to receive ECU fingerprints, the ECU fingerprints comprising the plurality of fingerprint feature sets.

### Example 18

The computer-readable storage medium of claim 15, the instructions when executed by the circuitry cause the circuitry to generate the plurality of feature sets based in part on physical characteristics of the plurality of messages.

### Example 19

The computer-readable storage medium of claim 15, the instructions when executed by the circuitry cause the circuitry to: determine, for each of the plurality of messages, a physical characteristic of the message; designate a first message of the plurality of messages as belonging to a first feature set of the plurality of feature sets based on the physical characteristics of the first message; and designate a second message of the plurality of messages as belonging to a first set of the plurality of feature sets based on the physical characteristics of the second message, wherein the physical characteristic of the first message is within a threshold value of the physical characteristic of the second message.

### Example 20

The computer-readable storage medium of claim 19, the instructions when executed by the circuitry cause the circuitry to designate a third message of the plurality of messages as belonging to a second feature set of the plurality of feature sets based on the physical characteristics of the third message, wherein the physical characteristic of the third message is outside a threshold value of the physical characteristic of the first message or the second message.

### Example 21

The computer-readable storage medium of claim 15, the IVN a controller area network (CAN) bus, CAN FD, a FlexRay bus, an automotive ethernet bus, or a local interconnected network (LIN) bus.

### Example 22

A method, comprising: reading, from a communication bus, a plurality of messages generated by a plurality of electronic control units (ECUs), generating, based in part on the plurality of messages, a plurality of feature sets, and establishing a ground truth for the plurality of ECUs based in part on the plurality of feature sets.

### Example 23

The method of claim 22, comprising comparing the plurality of feature sets to a plurality of fingerprint feature sets associated with the plurality of ECUs.

### Example 24

The method of claim 23, comprising receiving ECU fingerprints, the ECU fingerprints comprising the plurality of fingerprint feature sets.

### Example 25

The method of claim 22, comprising generating the plurality of feature sets based in part on physical characteristics of the plurality of messages.

### Example 26

The method of claim 22, comprising: determining, for each of the plurality of messages, a physical characteristic of the message; designating a first message of the plurality of messages as belonging to a first feature set of the plurality of feature sets based on the physical characteristics of the first message; and designating a second message of the plurality of messages as belonging to a first set of the plurality of feature sets based on the physical characteristics of the second message, wherein the physical characteristic of the first message is within a threshold value of the physical characteristic of the second message.

### Example 27

The method of claim 26, comprising designating a third message of the plurality of messages as belonging to a second feature set of the plurality of feature sets based on the physical characteristics of the third message, wherein the physical characteristic of the third message is outside a threshold value of the physical characteristic of the first message or the second message.

### Example 28

The method of claim 22, the communication bus a controller area network (CAN) bus, CAN FD, a FlexRay bus, an automotive ethernet bus, or a local interconnected network (LIN) bus.

### Example 29

An apparatus, comprising means arranged to implement the function of any one of claims 22 to 28.

What is claimed is:

1. An apparatus comprising:
processing circuitry; and
memory coupled to the processing circuitry, the memory comprising instructions that when executed by the processing circuitry cause the processing circuitry to:
read, from a communication bus, a plurality of messages generated by a plurality of electronic control units (ECUs),
generate, based in part on the plurality of messages, a plurality of feature sets, and
establish a ground truth for the plurality of ECUs based in part on the plurality of feature sets.

2. The apparatus of claim 1, the instructions when executed by the processing circuitry cause the processing circuitry to compare the plurality of feature sets to a plurality of fingerprint feature sets associated with the plurality of ECUs.

3. The apparatus of claim 2, the instructions when executed by the processing circuitry cause the processing circuitry to receive ECU fingerprints, the ECU fingerprints comprising the plurality of fingerprint feature sets.

4. The apparatus of claim 1, the instructions when executed by the processing circuitry cause the processing circuitry to generate the plurality of feature sets based in part on physical characteristics of the plurality of messages.

5. The apparatus of claim 1, the instructions when executed by the processing circuitry cause the processing circuitry to:
determine, for each of the plurality of messages, a physical characteristic of the message;
designate a first message of the plurality of messages as belonging to a first feature set of the plurality of feature sets based on the physical characteristics of the first message; and
designate a second message of the plurality of messages as belonging to a first set of the plurality of feature sets based on the physical characteristics of the second message, wherein the physical characteristic of the first message is within a threshold value of the physical characteristic of the second message.

6. The apparatus of claim 5, the instructions when executed by the processing circuitry cause the processing circuitry to designate a third message of the plurality of messages as belonging to a second feature set of the plurality of feature sets based on the physical characteristics of the third message, wherein the physical characteristic of the third message is outside a threshold value of the physical characteristic of the first message or the second message.

7. The apparatus of claim 1, the communication bus a controller area network (CAN) bus, CAN FD, a FlexRay bus, an automotive ethernet bus, or a local interconnected network (LIN) bus.

8. A system, comprising:
a communication bus;
a plurality of electronic control units coupled to the communication bus; and
a ground truth fingerprint device, comprising:
processing circuitry; and
memory coupled to the processing circuitry, the memory comprising instructions that when executed by the processing circuitry cause the processing circuitry to:
read, from a communication bus, a plurality of messages generated by a plurality of electronic control units (ECUs),
generate, based in part on the plurality of messages, a plurality of feature sets, and
establish a ground truth for the plurality of ECUs based in part on the plurality of feature sets.

9. The system of claim 8, the instructions when executed by the processing circuitry cause the processing circuitry to compare the plurality of feature sets to a plurality of fingerprint feature sets associated with the plurality of ECUs.

10. The system of claim 9, the instructions when executed by the processing circuitry cause the processing circuitry to receive ECU fingerprints, the ECU fingerprints comprising the plurality of fingerprint feature sets.

11. The system of claim 8, the instructions when executed by the processing circuitry cause the processing circuitry to generate the plurality of feature sets based in part on physical characteristics of the plurality of messages.

12. The system of claim 8, the instructions when executed by the processing circuitry cause the processing circuitry to:
determine, for each of the plurality of messages, a physical characteristic of the message;
designate a first message of the plurality of messages as belonging to a first feature set of the plurality of feature sets based on the physical characteristics of the first message; and
designate a second message of the plurality of messages as belonging to a first set of the plurality of feature sets based on the physical characteristics of the second message, wherein the physical characteristic of the first message is within a threshold value of the physical characteristic of the second message.

13. The system of claim 12, the instructions when executed by the processing circuitry cause the processing circuitry to designate a third message of the plurality of messages as belonging to a second feature set of the plurality of feature sets based on the physical characteristics of the third message, wherein the physical characteristic of the third message is outside a threshold value of the physical characteristic of the first message or the second message.

14. The system of claim 8, the communication bus a controller area network (CAN) bus, CAN FD, a FlexRay bus, an automotive ethernet bus, or a local interconnected network (LIN) bus.

15. A computer-readable storage medium for a ground truth fingerprint device of an in-vehicle network (IVN), that medium comprising instructions for execution by circuitry, which when executed by the circuitry cause the circuitry to:
read, from an in-vehicle network (IVN), a plurality of messages generated by a plurality of electronic control units (ECUs),
generate, based in part on the plurality of messages, a plurality of feature sets, and
establish a ground truth for the plurality of ECUs based in part on the plurality of feature sets.

16. The computer-readable storage medium of claim 15, the instructions when executed by the circuitry cause the circuitry to compare the plurality of feature sets to a plurality of fingerprint feature sets associated with the plurality of ECUs.

17. The computer-readable storage medium of claim 16, the instructions when executed by the circuitry cause the circuitry to receive ECU fingerprints, the ECU fingerprints comprising the plurality of fingerprint feature sets.

18. The computer-readable storage medium of claim 15, the instructions when executed by the circuitry cause the circuitry to generate the plurality of feature sets based in part on physical characteristics of the plurality of messages.

19. The computer-readable storage medium of claim 15, the instructions when executed by the circuitry cause the circuitry to:
determine, for each of the plurality of messages, a physical characteristic of the message;
designate a first message of the plurality of messages as belonging to a first feature set of the plurality of feature sets based on the physical characteristics of the first message; and
designate a second message of the plurality of messages as belonging to a first set of the plurality of feature sets based on the physical characteristics of the second message, wherein the physical characteristic of the first message is within a threshold value of the physical characteristic of the second message.

20. The computer-readable storage medium of claim 19, the instructions when executed by the circuitry cause the circuitry to designate a third message of the plurality of messages as belonging to a second feature set of the plurality of feature sets based on the physical characteristics of the third message, wherein the physical characteristic of the third message is outside a threshold value of the physical characteristic of the first message or the second message.

21. The computer-readable storage medium of claim 15, the IVN a controller area network (CAN) bus, CAN FD, a FlexRay bus, an automotive ethernet bus, or a local interconnected network (LIN) bus.
